(19) United States
(12) Patent Application Publication
(10) Pub. No.: US 2003/0056352 A1
(43) Pub. Date: Mar. 27, 2003

(54) Liner bolt removal tool

(76) Inventors: Dale C. McLellan, Burlingame, CA (US); John R. Kuyper, Harford, CA (US); Skip George Albert-Hill, Montara (CA); Frederick M. Whorff, Clovis, CA (US)

Correspondence Address: Richard A. Ryan, RYAN & ENGNATH, Suite 104, 8469 N. Millbrook, Fresno, CA, 93720, US

(21) Appl. No.: 09/739,613

(22) Filed: Dec. 19, 2000

(51) Int. Cl. B23P 19/04

(52) U.S. Cl. 29/252

(57) ABSTRACT

A tool for more quickly and efficiently removing the liner bolts that hold sections of liners to the inside of an ore grinding mill shell. The tool has thick-walled tubular barrel with a front cap assembly and a rear valve assembly at opposing ends. A projectile is slidably disposed in the barrel chamber. The rear valve assembly connects to a supply of compressed air to deliver compressed air to the chamber and cause the projectile to move rapidly forward toward the front end cap assembly and contact an impactor, which is in contact with the liner bolt to be removed. The forward movement of the projectile causes the impactor to move forward and drive the bolt out of the shell and liner. The tool has little recoil effect and utilizes a safety absorber to reduce the likelihood of damage or injury from use of the tool.

### BACKGROUND OF THE INVENTION

1. Field of the Invention

The field of the present invention relates generally to mechanical impact-type tools for removing bolts from a shell liner. Specifically, the present invention relates to such bolt removal tools that are pneumatically-operated. Even more specifically, the present invention relates to bolt removal tools that are suitable for removing the bolts that hold a liner to an external shell, such as those used in ore grinding mills.

2. Background

Many drum or drum-like apparatuses are used for grinding or tumbling materials placed inside the drum in order to effectuate a treatment on the materials, such as reduce the size of the materials or make them smoother. Commercial mining operations utilize large ore grinding mills, such as sag mills and ball mills, to comminute ore removed from a mine to prepare the ore for further treatment. These large ore grinding mills are very costly and typically comprise a drum, having an ore receiving end and an opposite ore discharging end, and a mechanism for rotating the drum about its longitudinal axis. The drum on these mills can be 20 to 28 feet or more in diameter and 12 to 15 feet in length. As the drum rotates, the ore is comminuted by being subject to various pressure and impact forces. Large metal balls are often used inside the drum to provide additional impact force to the ore so as to improve the efficiency of the grinding mill.

Because of the cost of equipment and the volume of ore necessary to obtain the desired product, the typical commercial mining operation, including the ore grinding mills, are intended to operate on a nearly continuous (i.e., 24 hours a day) basis. Depending on the size of the drum and the mining operations, the drum treats very large quantities of ore. As a result, the drums are subject to considerable impact force and internal wear from the ore and other materials in the drum during the comminution of the ore. Unless some provision is made to protect the drum during the comminution of the ore, it will quickly wear out and necessitate replacement or repair of the expensive drum. In addition to the direct cost, there would also be considerable cost that would result from the downtime of the mining operations while the ore grinding mill drum is replaced. These costs would make the use of grinding mills virtually impractical for the typical commercial mining operation.

The generally accepted mechanism for protecting the inside of the grinding mill drum from damage and wear is to utilize a replaceable liner inside the drum. Due to the size of the grinding mill, the liner is typically manufactured in a number of individual sections which are removably mounted to the inside of the drum, or the “shell,” of the grinding mill. The use of sectional liners of manageable sizes allows the liners to be manufactured from a variety of different metals, such as chromally blends, that are desired to better resist damage and wear. When the drum is manufactured, the shell contains a series of rows of mounting holes drilled into the shell in the radial direction (i.e., perpendicular to the axis of rotation of the mill) for attachment of the liner sections. The liner sections are typically mounted to the shell utilizing bolts having a head at one end and threads at the opposite end. The bolt head is received against the liner segment and the threaded end of the bolt extends outward from the shell. A nut, threadably received by the portion of the bolt protruding from the shell, is tightened against the shell to secure the liner to the inside of the shell.

After a period of use, typically four to six months depending on the ore material and the metallurgy of the liner, the liner sections are worn down to the point that they must be replaced in order to continue to protect the expensive drum. In order to result in as minimum amount of downtime as possible, liner and shell design has been directed towards facilitating rapid replacement of the liner. Unfortunately, even with improved liner designs, downtime during liner replacement is a major problem for most commercial mining operations. For a typical mill, it can take as long as five to eight days working three shifts at 24 hours a day to replace worn liners and get the mill back in operation. Due to the nature of the mining business, this downtime can cost many thousands, if not hundreds of thousands, of dollars in lost mining production.

The single most time consuming aspect of liner replacement is the removal of the bolts that hold the liners to the shell. Removal of the bolts requires unthreading the nut on the outside of the shell and then forcing the bolt out of its hole in the direction of the interior of the drum. Once all the bolts holding a particular liner section are removed, the liner section is taken out of the mill and a new liner section is put in its place. To complicate matters, however, during the comminuting process the ore and other materials in the mill impact against the liner and bolt head. This results in the bolt heads being flattened and the liner being bent over the head of the bolt, making the bolt extremely difficult to remove. As a result, the removal of the bolts is currently the limiting factor for reducing the amount of time the mill is out of operation.

Over the last 100 years or so, there has been very little improvement made in removing liner bolts from grinding mills. One common method of removing liner bolts is the use of a sledgehammer to drive the bolt out of shell and liner section. For the bolts on the end of the mill, which at twenty-eight to thirty inches long tend to be longer than the bolts along the sides, it can take hundreds of hits to drive the bolt through the mounting hole. This process can take thirty minutes to two hours per bolt for removal. Even with this effort, some bolts are not able to be removed and must be melted out with a torch. The bolts along the side of the mill, which are typically twelve inches or so long, also require considerable effort to remove with the typical sledgehammer. In addition to the time problems, the use of a sledgehammer is very labor intensive and has a relatively high risk of injury, particularly long term, to the workers.

As an alternative to the sledgehammer, there are some mechanical devices for liner bolt removal. One of these devices is a battering ram comprised of a solid bar, such as eight inch round stock, having handles on the sides. Typically, four workers hold on to the battering ram and repeatedly drive it into the end of the liner bolt to force the bolt out of the mounting hole. The battering ram method of liner bolt removal is also very labor intensive and has a relatively high risk of injury. To reduce the labor intensiveness of removing liner bolts, others in the mining industry have utilized a hydraulic chisel apparatus to repeatedly pound the bolt out of a mounting hole. One such chisel apparatus that is used to remove liner bolts is the hydraulic rock and demolition breakers by INDECO of Bridgeport, Conn. These devices utilize a chisel mounted on the end of a reciprocating, hydraulically powered piston that is able to deliver approximately 60 blows per minute at a typical force level of approximately 1500 Joules (much like a jackhammer). Although these devices work well for their intended chiseling purposes (i.e., rock, concrete, pavement and other material breakup) and can reduce the amount of personnel required to remove liner bolts, they do not significantly reduce the amount of time necessary to remove liner bolts (which is not the intended purpose of these devices). In addition to requiring significant time, these chiseling devices can be difficult to line up with the bolt and to maintain that alignment during the bolt removal process. As a result, the chisel end of the device can hit the shell, resulting in potentially expensive damage to the mill and risk of injury to the workers holding or guiding the device into the mounting hole.

It can be appreciated, therefore, that what is needed is a tool for quickly, safely and efficiently removing the bolts that are used to attach a liner to a shell of a grinding mill. The desirable tool would be suitable for use by as few workers as possible and reduce the risk of injury to those workers relative to the present methods and devices for removing liner bolts.

### SUMMARY OF THE INVENTION

The liner bolt removal tool of the present invention solves the problems and provides the benefits identified above. That is to say, the present invention provides a tool that substantially reduces the amount of time necessary to remove liner bolts and does so in a manner that requires less manpower and reduces the risk of injury to the workers utilizing the tool. As a result of the use of the tool of the present invention, the grinding mill can be placed back into operation much sooner, thereby reducing lost income for the mining operations.

In the primary embodiment of the present invention, the liner bolt removal tool comprises a tubular barrel having a front cap assembly at one end and a rear valve assembly at the opposite end. A projectile is freely and slidably disposed in the chamber of the barrel. The rear valve assembly has an inlet configured to connect to a supply of compressed air, such as that commonly used in commercial mining operations, and an outlet that is in communication with the barrel chamber so as to deliver compressed air to the chamber and cause the projectile to move forward toward the front end cap assembly. The front end cap assembly has an impactor having a first end that contacts the liner bolt to be removed and a second end that interfaces with the chamber to be impacted by the projectile. The forward movement of the projectile causes the impactor to move forward and drive the bolt out of the shell and liner and into the interior of the drum.

Upon initiation of the bolt removal process, compressed air is delivered to the inlet of the rear valve assembly and through the outlet to project the projectile forward through the chamber of the barrel toward the front end cap assembly. At the forward end of the barrel the projectile hits the second end of the impactor, causing it to move forward so that the first end of the impactor strikes the bolt and drives it through the shell and liner where it will fall to the bottom of the drum. The tool of the present invention delivers a single blow of approximately 3,200 foot-lbs force to the bolt. As a result, most bolts are driven out of the shell and liner with only one hit. Some bolts may require two or more hits. The use of the liner bolt removal tool of the present invention significantly reduces the amount of time, labor and downtime currently associated with removing liner bolts from commercial grinding mills.

The tool of the present invention substantially reduces the amount of recoil from what one would expect of such a device by utilizing a large amount of mass for the barrel relative to the projectile. The use of side bars along the outside of the barrel in a direction generally parallel to the longitudinal axis of the barrel can further reduce recoil. The present invention also includes an impact absorbing mechanism in the front end cap assembly that absorbs the impact of the projectile against the front end cap to limit movement of the impactor when the tool is fired against air (i.e., not against a bolt). The recoilless and impact absorbing features makes the tool easier to use and improves the safety aspect of removing liner bolts. A bolt guide at the end of front end cap assembly keeps the impactor aligned with the bolt. Wear rings around the projectile seal the annular space between the interior wall of the chamber and the projectile to facilitate compressed air moving the projectile at a high rate of speed. In the preferred embodiment, the cylindrically-shaped projectile is made of material that is softer (relative) than the material used for the impactor. The end of the projectile that impacts the impactor is configured with a smaller diameter to allow that end to expand upon impact with the impactor without changing the outside diameter of the projectile. The opposite end of the projectile has a projectile connector that interacts with a connector at the rear valve assembly end of the barrel to hold the projectile in place prior to firing. This optimizes the starting distance between the impactor and the projectile, which allows the projectile to achieve the desired velocity, and permits the tool to be used at angles that would cause the projectile to fall against the impactor (i.e., vertical or near-vertical angles).

In use, the users align the tool against the bolt to be removed and hold the tool in place. A button is pushed on the control panel causing compressed air to flow into the rear valve assembly, the latch connector to release the projectile connector, a venting mechanism at the front of the barrel to open and compressed air to project the projectile toward the impactor. As the projectile moves forward, air is vented out the chamber through the front valve assembly. The impact of the projectile against the impactor drives the impactor against the bolt with sufficient force to cause the bolt to be knocked out of the shell and liner. After the bolt is removed, the reload button on the control panel is pressed to cause compressed air to be injected through the front valve assembly into the forward end of the barrel to move the projectile back toward the second end of the barrel where the projectile connector connects to the latch connector. Air is vented out through the rear valve assembly during the rearward movement of the projectile. When the projectile is in place, the tool can be moved to another bolt and re-fired. In this manner, all the bolts that hold the liner sections to the shell can be removed. Use of the tool can reduce the amount of time to replace a liner from the current five to eight days (at twenty-four hour shifts) to only three to six days, with the bolt removal no longer being the limiting factor on replacing grinding mill liners.

Accordingly, the primary objective of the present invention is to provide a liner bolt removal tool having the features generally described above and more specifically described below in the detailed description.

It is also an important objective of the present invention to provide a liner bolt removal tool that utilizes pressurized air to safely, easily and with less downtime remove liner bolts.

It is also an important objective of the present invention to provide a liner bolt removal tool that is adaptable for use with overhead cranes, framing systems and stands for alignment of the tool with liner bolts in large commercial mining grinding mills.

It is also an important objective of the present invention to provide a liner bolt removal tool that utilizes a tubular barrel having a front end cap assembly on one end, a rear valve assembly on the opposite end and a projectile slidably disposed therein.

Yet another important objective of the present invention is to provide a liner bolt removal tool that projects a projectile into an impactor slidably disposed within a front cap assembly to cause the impactor to drive the liner bolt out of the shell and liner of an ore grinding mill.

It is a further objective of the present invention to provide a pneumatically powered liner bolt removal tool that utilizes compressed air to activate connector release mechanisms, project the projectile towards a impactor and move the projectile back to the connector mechanism.

The above and other objectives of the present invention will be explained in greater detail by reference to the attached figures and the description of the preferred embodiment which follows. As set forth herein, the present invention resides in the novel features of form, construction, mode of operation and combination of parts presently described and understood by the claims.

### BRIEF DESCRIPTION OF THE DRAWINGS

In the drawings which illustrate the best modes presently contemplated for carrying out the present invention:

FIG. 1 is an isometric top view of the preferred embodiment of the present invention;

FIG. 2 is an exploded isometric view of the embodiment of the present invention;

FIG. 3 is an isometric bottom view of the preferred embodiment of the present invention;

FIG. 4 is a cross-sectional isometric view of the preferred embodiment of the present invention;

FIG. 5 is a cross-sectional isometric view of the front end cap assembly of the present invention;

FIG. 6 is a cross-sectional side view of the front end cap assembly of the present invention prior to firing;

FIG. 7 is a cross-sectional side view of the front end cap assembly of the present invention showing the activation of the impact absorbing mechanism during a dry firing (i.e., when not against a liner bolt);

FIG. 8 is a rear isometric view of the rear valve assembly of the present invention;

FIG. 9 is a front isometric view of the rear valve assembly of the present invention;

FIG. 10 is an isometric view of the projectile of the preferred embodiment of the present invention;

FIG. 11 is a cross-sectional side view of the projectile of the present invention;

FIG. 12 is an exploded isometric view of an alternative embodiment of the present invention;

FIG. 13 is a bottom isometric view of the alternative embodiment of the present invention shown in FIG. 12;

FIG. 14 is a rear isometric view of an alternative embodiment of the rear valve assembly of the present invention;

FIG. 15 is a side cross-sectional view of an alternative embodiment of the projectile of the present invention;

FIG. 16 is an isometric view of an alternative embodiment of the latch connector of the present invention; and

FIG. 17 is an isometric view of the alternative embodiment of the present invention shown in FIGS. 12 and 13 attached to a stand assembly.

### DETAILED DESCRIPTION OF THE PREFERRED EMBODIMENTS

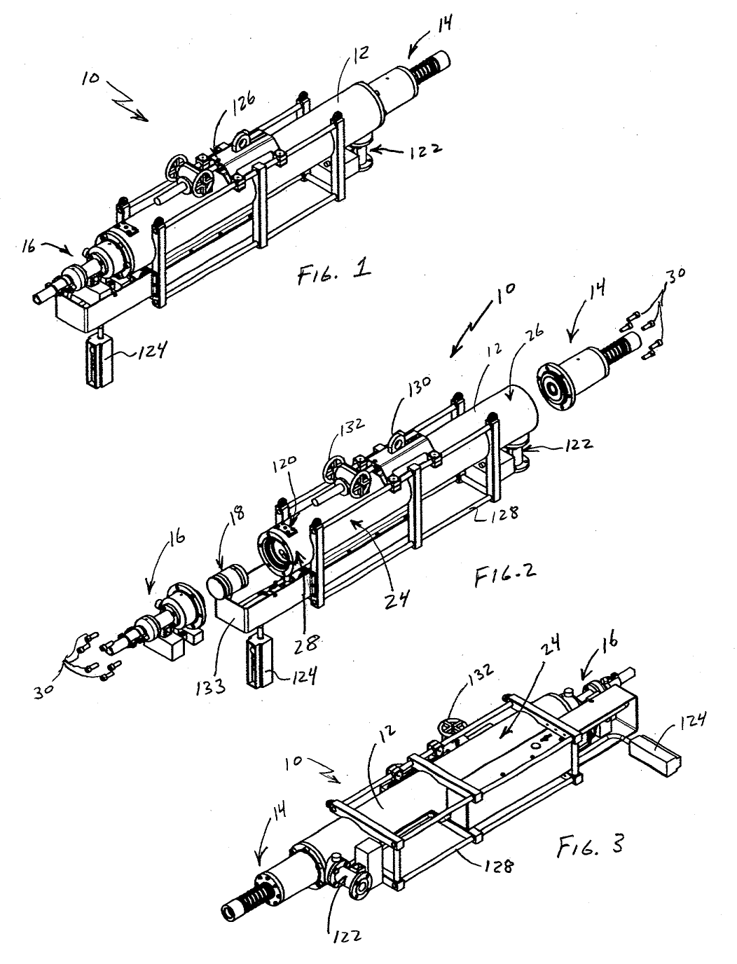

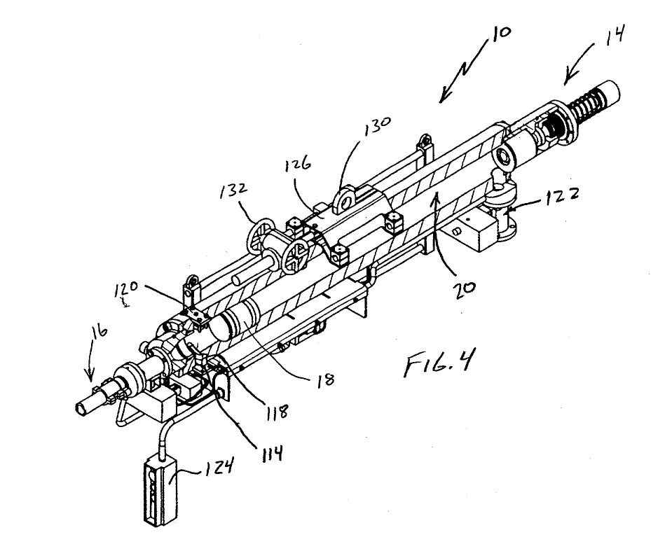

With reference to the figures where like elements have been given like numerical designations to facilitate the reader's understanding of the present invention, and particularly with reference to the preferred embodiment of the present invention illustrated in FIGS. 1 through 11, the preferred embodiment of the present invention is set forth below. The liner bolt removal tool, designated generally as 10, is primarily designed to remove the liner bolts that hold sections of liners to the inside of the shell that forms the drum used in commercial grinding mills. The bolts are typically 1 to 2 inches in diameter and approximately twelve inches long on the sides of the drum and twenty-eight to thirty inches long at the ends of the drum. When the liner is installed on the inside of the shell, the bolts are inserted through a hole in the liner and through the mounting hole in the shell such that they protrude from the exterior of the shell. A washer and nut are placed on the end of the bolt to hold the liner tightly against the inside of the shell. To remove the liners, the nut and washer are removed and then the bolt is forced back through the mounting hole and into the interior of the drum. Depending on the size of the ore grinding mill and number of bolts required to secure the liner, this process is repeated many hundreds of times.

Liner bolt removal tool 10 of the preferred embodiment of the present invention generally comprises tubular barrel 12, front end cap assembly 14, rear valve assembly 16 and projectile 18, as best shown in FIGS. 1 through 4. Inside barrel 12 is chamber 20 in which projectile 18 is slidably disposed. The outer surface of barrel 12 is designated 24, as shown in FIG. 2. Front end cap assembly 14 is at first end 26 of barrel 12 and rear valve assembly 16 is at second end 28 of barrel 12. In the preferred embodiment, as best shown in FIG. 2, front end cap 14 mounts directly to first end 26 and rear valve assembly 16 mounts directly to second end 28 of barrel 12 by providing bores in barrel 12 that are sized and configured to accept bolts 30.

In the preferred embodiment, tubular barrel 12 is a thick-walled tube that is configured to be relatively heavy, when compared to projectile 18, to reduce the recoil that would be otherwise expected from device 10. The mass of barrel 12 distributed radially around projectile 18 is so much greater than that of projectile 18, much like a 22 caliber rifle barrel and bullet, that the tool has very little recoil or is nearly recoilless, which makes the tool 10 safer to use and easier to hold in place against the exterior of the shell (i.e., without the need for any devices to secure the tool to the shell). In one embodiment of the present invention, barrel 12 has a five inch inside diameter bore forming chamber 20 and an outside diameter of ten inches and is made from steel. Other configurations of barrel 12 are also possible depending on the amount of force that would be required to remove a bolt from its mounting hole. The thickness of barrel 12, with its mass evenly distributed around chamber 20, provides a beneficial mass ratio relative to the mass of projectile 18 as projectile 18 moves through chamber 20, as further described below.

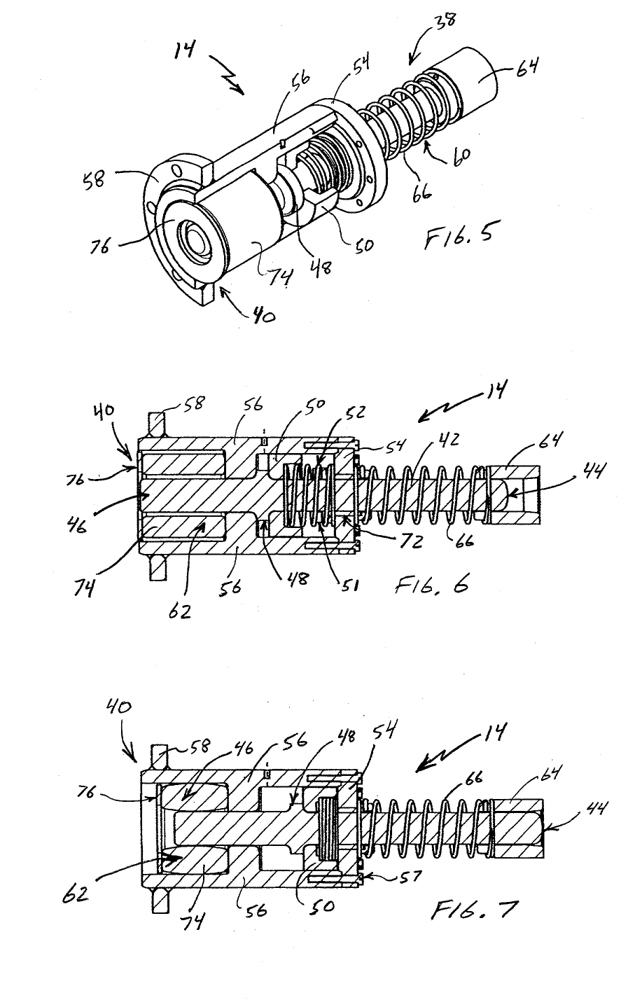

As shown in FIGS. 5, 6 and 7, front end cap assembly 14 has a first end 38, opposing second end 40 and impactor 42 reciprocately disposed between first end 38 and second end 40. During operation, first end 44 of impactor 42 abuts against the shell and over the end of the liner bolt (protruding from the shell) to be removed and second end 46 is impacted by the movement of projectile 18 to drive impactor 42 against the liner bolt and force it out of its mounting hole. In the preferred embodiment, impactor 42 is made out of a first material comprising a high strength metal alloy, such as those utilizing chrome, that are generally consistent with the materials utilized in the chisel manufacturing industry. These metals are typically high strength materials that are heat treated for optimum durability and, depending on the material, are forged to obtain the desired shape characteristics. In this embodiment, as best shown in FIG. 5, impactor 42 has a collar-shaped section 48 thereon to act as a stop. When moving in the forward direction, as a result of firing tool 10, collar 48 abuts against spring retainer 50 to compress bumper 51 between retainer 50 and front housing 54 to absorb any extra energy. After firing, spring 52 pushes impactor 42 back to its pre-firing position wherein second end 46 of impactor 42 is at chamber 20. In the preferred embodiment, front housing 54 mounts to rear housing 56 utilizing bolts 57, which allows impactor 42, bumper 51 and spring 52 to be replaced without removing front end cap assembly 14 from barrel 12. Rear housing 56 has a mounting plate 58 to mount front end cap 14 to barrel 12 utilizing bolts 30, as shown in FIG. 2. Although front end cap 14 may be mounted, attached or connected to barrel 12 by a variety of other methods known in the industry, the use of bolts 30 allows front end cap assembly 14 to be removed from barrel 12 for repair or replacement of the components therein. For particularly long liner bolts or for punching out the liner through knockout holes in the shell, a drift pin (not shown) can be used with impactor 42 to increase its effective length.

In the preferred embodiment of the present invention, front end cap assembly 14 of tool 10 also comprises a bolt guide assembly 60 and an impact absorbing assembly 62 that provide several important safety and operation benefits for tool 10. As best shown in FIGS. 5, 6 and 7, bolt guide 60 comprises guide ring 64 mounted to one end of guide spring 66. Guide ring 64 should be shaped and configured to go over the end of the liner bolt protruding from the exterior of the mill shell after the liner bolt nut is removed to guide impactor 42 so that it is generally aligned with the longitudinal axis of the liner bolt to better drive the bolt out of the shell and liner holes. In the preferred embodiment, the opposite end of spring 66 is attached to front housing 54 with dowel pins (not shown). Bearing 72 guides impactor 42 through front housing 54. In use, the tool 10 is placed in position at the liner bolt desired to be removed and then set against the side of the shell such that the guide ring 64 is around the liner bolt. The bolt guide 60 is pushed forward to retract guide ring 64 and compress spring 66 until first end 44 of impactor 42 is against the liner bolt. When tool 10 is fired, as explained below, impactor 42 drives the liner bolt through the shell and liner into the interior of the grinding mill drum. For safety purposes, bolt guide 60 also acts as a protective guard for personnel that could be hit by bolt fragments resulting from the impact of impactor 42 against the liner bolt.

Impact absorbing assembly 62 provides an important safety benefit in case tool 10 is “dry fired,” which refers to firing tool 10 when impactor 42 is not abutting against a liner bolt. Dry firing could damage the tool 10 and injure a person standing near the forward end of tool 10 when impactor 42 moves forward as a result of an impact by projectile 18. In the preferred embodiment, absorbing assembly 62 comprises absorber 74 contained in rear housing 56 by impact plate 76, which is in the shape of a large washer. As shown in FIGS. 5, 6 and 7, the preferred shape for absorber 74 is tubular to allow impactor 42 to be able to reciprocate through absorbing assembly 62. Preferably, absorber 74 is made from a compressible material that has sufficient strength to absorb the impact of projectile 18 against impact plate 76 and yet to compress inward against impactor 42. FIG. 6 shows the front end cap assembly 14 prior to when impactor 42 is hit by projectile 18 and FIG. 7 shows the assembly 14 after being hit by projectile 18 with absorber 74 compressing around impactor 42. Absorber 74 can be made out of a rubber material such as polyurethane or the like. Only when the tool 10 is dry fired or, in some circumstances, if the liner bolt is very easily removed from the shell and liner will the absorbing assembly function. When it does function, the impact of projectile 18 against washer 76 will force impact plate 76 forward to compress absorber 74 causing absorber 74 to compress and absorb the extra energy, thereby preventing damage to tool 10 and reducing the likelihood of injury to nearby workers.

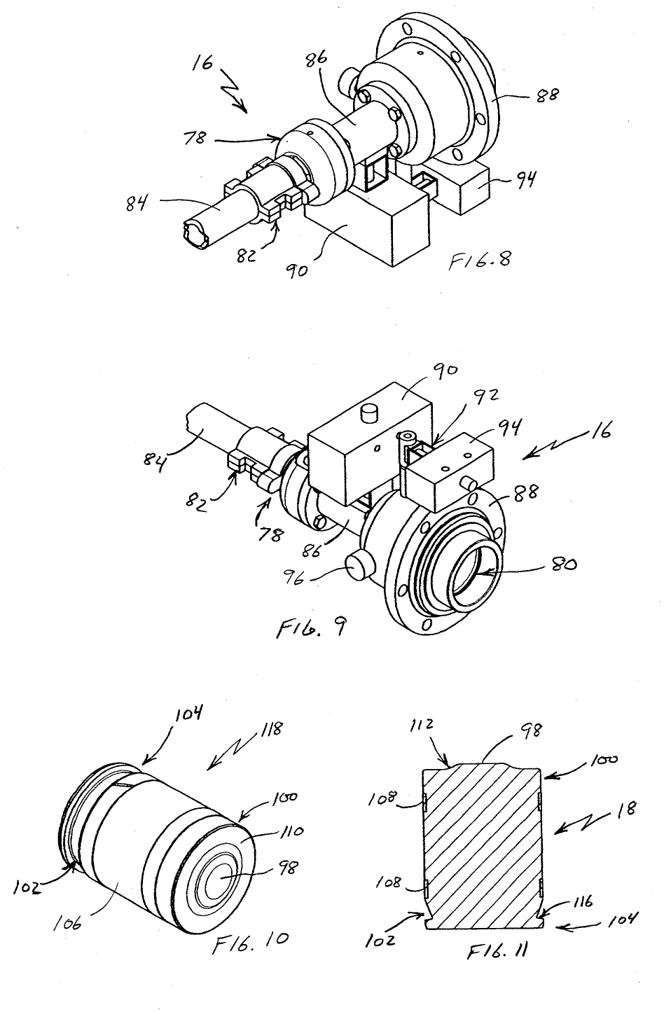

Rear valve assembly 16, shown best in FIGS. 8 and 9, is at second end 28 of barrel 12 and has an inlet 78 adaptable to connection to a supply of compressed air and an outlet 80 that is in communication with chamber 20 of barrel 12 to deliver the compressed air to chamber 20 to project the projectile 18 through chamber 20 and against second end 46 of impactor. As shown in FIGS. 8 and 9, the preferred embodiment of the present invention, inlet 78 has a connector suitable for connecting to the clamp 82 on an air supply hose 84, such as those commonly utilized in the commercial mining industry (as well as other industries) that connect to a central supply of compressed air, typically at 90 to 120 psi pressure. The same type of connectors are also used with local supplies of compressed air (i.e., air tanks). Upon activation of tool 10, compressed air flows through inlet 78 into valve body 86 and out outlet 80 to chamber 20 in barrel 12. In the preferred embodiment shown in FIGS. 8 and 9, flange 88 is configured to mount rear valve assembly directly to barrel 12 using bolts 30. Valve 86 should be sized and selected to facilitate pressurized air entering chamber 20 to rapidly project projectile 18 through chamber 20. In the preferred embodiment, valve 86 is a 1½″ ball valve having an actuator 90. Ball valves have the advantage of opening all the way to allow the full flow of compressed air into chamber 20 to project projectile faster. Ball valve, such as valve 86, are generally available in the sizes needed and are typically made of steel and have flanged ends. Alternatively, a shuttle valve can be used for valve 86. However, these valves are typically made of cast aluminum and can be difficult to find in the sizes needed. In the preferred embodiment rear valve assembly 16 also has an exhaust valve 92 with actuator 94 to exhaust air that would be compressed by the return of projectile 18 to rear valve assembly 16 after impacting impactor 42. Exhaust valve 92 can be a small (i.e., ¼″ size) ball valve. If desired, pressure gauge 96 can be utilized to monitor the pressure increase inside chamber 20.

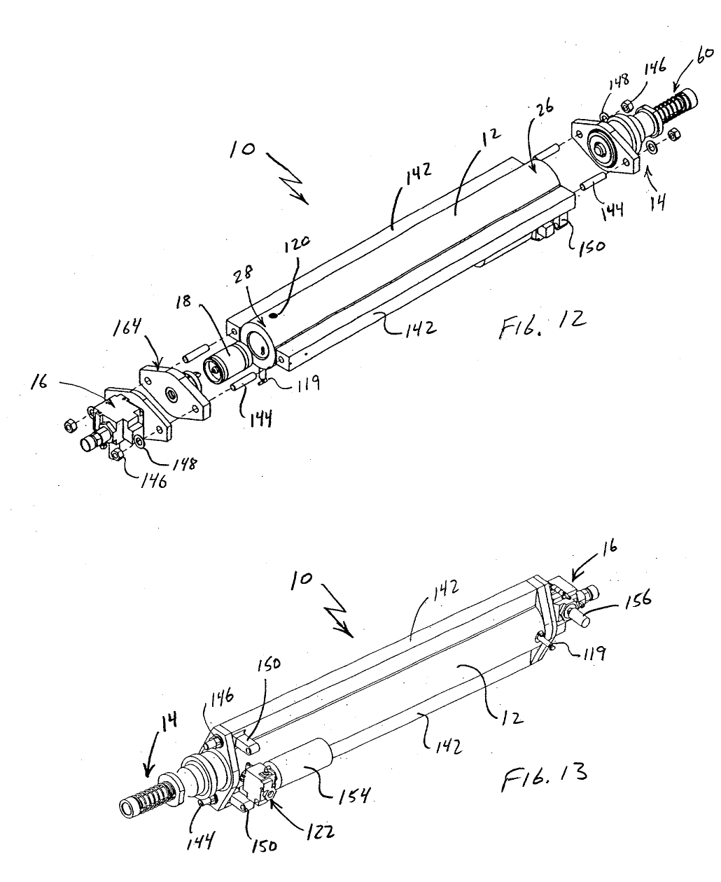

In the preferred embodiment of the present invention 10, projectile 18 is generally cylindrically shaped and has a shaped protrusion 98 at its first end 100 and a projectile connector 102 at its second end 104, as shown in FIGS. 10 and 11. Although other than cylindrical shapes are possible for projectile 18, the cylinder shape has the benefit of keeping first end 100 aligned in chamber 20 so that it will squarely contact second end 46 of impactor 42. In the preferred embodiment, projectile 18 is made out of a second material, such as case-hardened steel, that is softer (relatively) than the material (i.e., the chrome alloy material) used for impactor 42. Use of the softer material has the benefits described below with regard to the impact against impactor 42 without affecting clearances for projectile 18 and to prevent damage to impactor 42. Because projectile 18 is to be projected through chamber 20 by compressed air, it is necessary that the clearance between projectile 18 and chamber 20 be very tight (i.e., 0.010 to 0.015 inch) to avoid loss of compressed air around projectile 18. To avoid wear of outer surface 106 of projectile 18 and to better seal the annular space between projectile 18 and the wall of chamber 20, one or more wear rings 108 can be disposed around projectile 18, as best shown in FIG. 11. Wear rings 108 can be made out of Teflon or other suitable materials that can both seal and prevent wear to projectile 18.

In the preferred embodiment of the present invention 10, first end 100 of projectile 18 is shaped and configured to allow for “mushrooming” of the projectile upon impact with the second end 46 of impactor 42 without affecting the tight clearance between the projectile 18 and chamber 20. As shown in FIGS. 10 and 11, the top surface 110 of projectile 18 has a protrusion 98 extending therefrom. The shape and diameter of protrusion 98 should be approximately equal to the shape and diameter of second end 46 of impactor 42 and be able to fit through the center of impact plate 76. As shown in FIG. 11, the transition from top surface 110 to protrusion 98 is a relatively large curving radius 110. This radius 110 facilitates protrusion 98 expanding upon impact with second end 46 of impactor 42 without causing the overall diameter of projectile 18 to increase and, thereby, possibly sticking projectile 18 in chamber 20. In the dry firing situation, the top surface 110 would impact against impact plate 76 and compress absorber 74 to absorb extra energy, as described above.

To allow use of tool 10 at positions other than level or upwardly pointing and to ensure that projectile 18 is the proper distance from impactor 42, the preferred embodiment of the present invention utilizes projectile connector 102 at the second end 104 of projectile 18 and latch connector 114 at second end 28 of tubular barrel 12. Maintaining the proper distance between projectile 18 and impactor 42 allows projectile 18 to obtain the velocity and force necessary to drive the liner bolt out of the shell and liner. In the preferred embodiment, projectile connector 102 is groove-shaped section at the second end 104 of projectile 18 that forms a ledge area 116 that facilitates engagement and release by latch connector 114. Latch connector 114 is a pressure actuated plate member 118 that slides in and out of chamber 20 to selectively engage or release projectile 18 at projectile connector 102. A pneumatic cylinder 119 can be used to slide plate member 118 away from projectile 18 and disengage latch connector 114 from projectile connector 102 upon firing of tool 10 so as to allow projectile 18 to be able to freely move through chamber 20. In the preferred embodiment, cylinder 119 would open latch connector 114 a few milliseconds prior to releasing the compressed air into chamber 20. In this manner, tool 10 can be used at any angle without affecting the distance between projectile 18 and impactor 42 prior to firing. A latch indicator 120, such as those having an indicator button that will pop-up, can be mounted on tubular barrel 12 to indicate when projectile 18 is at the second end 28 of barrel 12 and engaged by latch connector 114. The use of latch indicator 120 improves the safety aspects of device 10 by reducing the likelihood of firing device 10 without projectile 18 in it proper location. This can be further improved by connecting the latch indicator 120 to the firing mechanism such that the tool 10 cannot be fired unless projectile 18 is securely engaged by latch connector 114.

The preferred embodiment of the present invention also includes a front valve assembly 122 located near first end 26 of barrel 12, as best shown in FIGS. 2 and 4. Front valve assembly 122 includes an exhaust valve, such as a 2″ ball valve, to allow air to vent from chamber 20 when the projectile 18 moves forward to the impactor 42 during firing. Venting of air through front valve assembly 122 is necessary to prevent the air in chamber 20 from being compressed by projectile 18, which would slow projectile 18 down and possibly prevent it from reaching impactor 42 at all. Preferably, front valve assembly 122 merely opens the chamber to the atmosphere during the venting process. Front vent assembly 122 also allows compressed air to be injected into chamber 20 at the front end 26 of barrel 12 after the projectile 18 has impacted against impactor 42. A small volume of air is injected into chamber 20 to move projectile 18 back to second end 28 of barrel 12 where projectile connector 102 can connect to latch connector 114. The volume and rate of air should be low enough that the impact of projectile 18 against latch connector 114 does not damage the tool 10 components. During the movement of projectile 18 from first end 26 to second 28 of barrel 12, exhaust valve 92 in the rear valve assembly 16 opens to allow air in chamber 20 to vent out the rear valve assembly 16.

The tool 10 of the present invention is connected to control pendant 124 having controls to (1) open the exhaust vent at the front valve assembly 122 and fire tool 10 by opening latch connector 114 to release projectile connector 102 and allowing compressed air to flow into chamber 20 to rapidly move projectile 18 from second end 28 to first end 26 of barrel 12 to drive impactor 42 against the liner bolt; and (2) reload tool 10 by injecting a small amount of compressed air through front valve mechanism 122 to move projectile 18 from first end 26 to second end 28 of barrel 12 where latch connector 114 can engage projectile connector 102 to lock projectile 18 in place and ready for removing the next bolt. If desired, control panel 124 can also include a variety of indicator lights which indicate the status of tool 10 and the position of projectile 18 in barrel 12.

To best use the tool 10 of the present invention, it should be attached to or mounted on a suspension assembly 126, such as that shown in FIGS. 1 through 4. One embodiment of suspension assembly 126 includes frame 128 that is welded to the outer surface 24 of barrel 12 to support tool 10 so that it can hang from the overhead crane systems found in most commercial mining operations. The overhead crane connects to ring member 130. Suspension assembly 126 also protects tool 10 from damage that could result from contact with tool 10. In addition, the use of a welded-on suspension assembly 126 also adds weight to tool 10, further reducing the likelihood of recoil. If desired, suspension assembly 126 can include spacer elements (not shown) to keep tool 10 a sufficient distance from the shell to prevent damage to tool 10 or the shell that could result from tool 10 swinging from the overhead crane system. Suspension assembly 126 can have control wheel 132 to adjust the position of tool 10, by moving along frame 128, relative to the liner bolt being removed. If desired, various protecting devices, such as rear guard 133, can be used to protect the more contact sensitive components of tool 10.

Alternatively, tool 10 can be used with a stand assembly, such as that identified as 134 in FIG. 17, for those mining operations that have ground access to the grinding mill liner bolts or that have platforms which allow access to the liner bolts. If there is sufficient room, stand assembly 134 can be used to hold tool 10 next to the liner bolt to remove. Stand assembly 134 can include various frame members 136 configured to adjustably hold tool 10 at various angles against the shell of a grinding mill. Stand assembly 134 can have various controls 138 to adjust the position of tool 10 relative to the liner bolt needing to remove and adjustable legs 140 to adjust the height and level of tool 10. Alternatively, if desired, tool 10 can also be attached to the tines of a forklift or similar device that allows tool 10 to be aligned with the liner bolts needing to be removed. For particularly small grinding mills, having smaller bolts that are generally easier to remove, the tool 10 of the present invention can be made small enough to be hand-held.

In operation, tool 10 is placed alongside the grinding mill that needs to have the bolts removed to replace the liner sections inside the shell. The workers connect inlet 78 of rear valve assembly 16 to the mining operations' compressed air supply or to a local compressor that is capable of providing compressed air at sufficient pressure. The workers then align bolt guide 60 against the liner bolt to be removed and press the tool 10 against the shell so as to compress guide spring 66 and contact first end 44 of impactor 42 against the liner bolt. One or more arming buttons on control pendant 124 are pushed to activate the firing sequence by opening the vent at front valve assembly 122 and releasing projectile connector 102 from latch connector 114 so that the compressed air will flow through rear valve assembly 16 into chamber 20 to rapidly push projectile 18 through chamber 20 so that it strikes second end 46 of impactor 42 with sufficient force to drive the liner bolt out of the shell and liner. For safety and operational purposes, control pendant 124 can be configured such that two buttons have to be held down together in order for tool 10 to fire. As projectile 18 moves forward through barrel 12, air is vented out chamber 20 through front valve assembly 122. After each hit against a liner bolt, the user pushes the reload button on control pendant 124 to cause compressed air to be injected through front valve assembly 122 into the first end 26 of barrel 12 to move projectile 18 back toward second end 28 of barrel 12 so latch connector 114 will engage projectile connector 102 and lock projectile 18 in place at the second end 28 of barrel 12. Air in chamber 20 is vented out through the exhaust valve 92 in rear valve assembly 16 during the rearward movement of projectile 18. When projectile 18 is in place, the shell can be rotated or the tool 10 moved such that tool 10 is aligned with another bolt. In this manner, all the bolts that hold the liner sections to the shell can be removed.

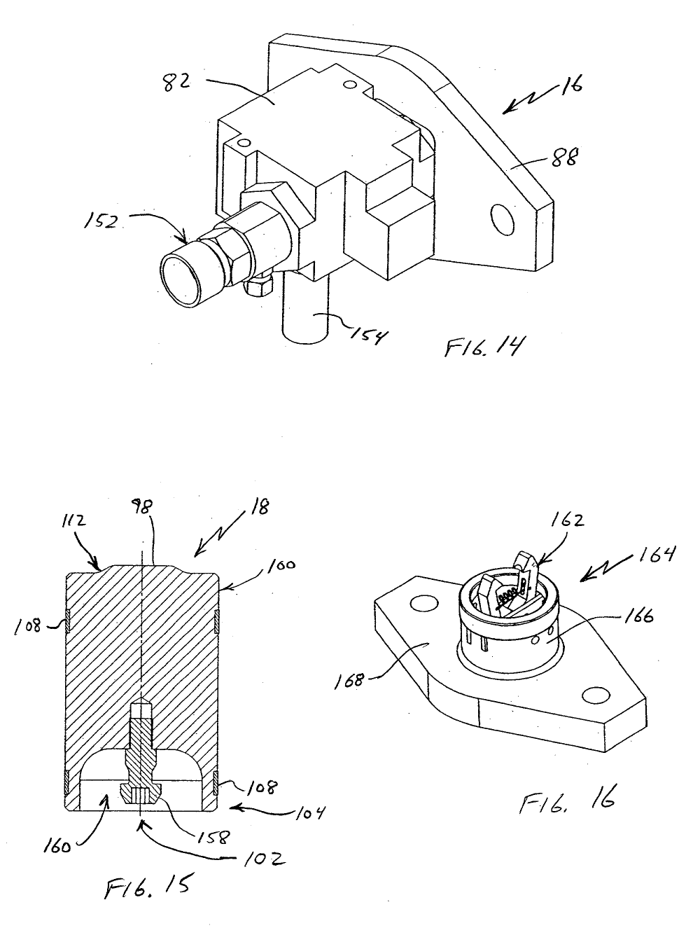

In an alternative embodiment of the present invention, shown in FIGS. 12 and 13, a pair of elongated side bars 142 can be attached to the outer surface 24 of barrel 12 to increase the mass of barrel 12 relative to projectile 18. Side bars 142 are mounted so as to be parallel to the longitudinal axis of barrel 12 to balance the mass of barrel 12 along the path of projectile 18. Side bars 142 can be welded to the outer surface 24 of barrel 12 or attached a variety of other ways as would be known to those skilled in the art. As shown in FIG. 12, front end cap 14 and rear valve assembly 16 can be attached to the ends of side bars 142 utilizing a double threaded bolt 144 with a nut 146 and washer 148 at the end of bolt 144. Protruding downward from side bars 142 is mounting post 150, as shown in FIGS. 12 and 13, that are used to mount tool 10 to an assembly for attachment to a stand or suspension system. In addition, mounting post 150 can be connected to and protrude downward from barrel 12.

In the alternative embodiment, rear valve assembly 16 can have valve 86, which can be a shuttle valve, attached to mounting plate 88 for mounting onto side bars 142 and a quick-release type connector 152 at the inlet of assembly 16, as shown in FIG. 14. These connectors generally have a female threaded end suitable for threadably receiving the male end connector affixed to the air supply hoses. As also shown in FIG. 14, a small muffler 154 can be attached to rear valve assembly 16 to reduce the noise level of the air venting out rear valve assembly 16. If desired, front vent assembly 116 can also have muffler 156 to reduce the noise of the air as it vents out of front vent assembly 122.

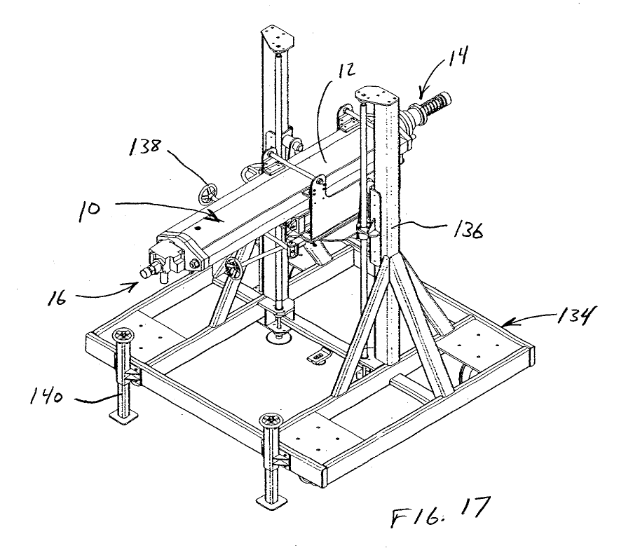

FIGS. 15 and 16 illustrate alternative embodiments for projectile 18 and the mechanism for latching onto projectile 18. In the alternative embodiment, projectile connector 102 can comprise a protruding member 158 inside cavity 160, as shown in FIG. 15. Protruding member 158 of projectile connector 102 is sized and configured to be engaged by alternative latch connector 162 upon contact by projectile 18 against rear end cap 164. As shown in FIG. 16, latch connector 162 is positioned in connector housing 166 mounted on plate 168. Connector housing 166 should be shaped and configured to fit within cavity 160. Plate 168 should be configured to attach mounting plate 88 of rear valve assembly 16, such that rear end cap 164 is disposed between the second end 28 of barrel 12 and rear valve assembly 16, as shown in FIG. 12. Although the preferred and alternative embodiments of the present invention have been shown and described with pneumatically controlled valves (i.e., the front 122 and rear 16 valve assemblies), it should be understood that other valve control mechanisms, such as magnetic solenoid controlled valves, can be utilized in conjunction with the present invention.

While there is shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape, and use.

What is claimed is:

1. A liner bolt removal tool for removing a liner bolt, comprising:
a tubular barrel having a first end, an opposing second end, an outer surface and a chamber disposed therein;
a projectile slidably disposed in said chamber of said barrel;
a front end cap assembly disposed at said first end of said barrel, said front end cap assembly having a first end, second end and an impactor reciprocately disposed therein, said impactor having a first end to impact the liner bolt and a second end in communication with said chamber of said barrel to be impacted by said projectile; and
a rear valve assembly disposed at said second end of said barrel, said rear valve assembly having an inlet adaptable for connection to a supply of compressed air and an outlet in communication with said chamber for delivery of compressed air to said chamber to project said projectile against said second end of said impactor.

2. The liner bolt removal tool according to claim 1, wherein said projectile is made of a first material that is softer than a second material used for said impactor.

3. The liner bolt removal tool according to claim 1, wherein said projectile comprises at least one wear ring disposed around said projectile, said wear rings sized and configured to tightly dispose said projectile in said chamber.

4. The liner bolt removal tool according to claim 1, wherein said projectile is cylindrically shaped, said projectile having a first end and an opposing second end.

5. The liner bolt removal tool according to claim 4, wherein said first end of said projectile is shaped and configured to expand upon impact with said impactor without an increase in the diameter of said projectile.

6. The liner bolt removal tool according to claim 4 further comprising a projectile connector at said second end of said projectile, said projectile connector configured to releasably connect to a latch connector at said second end of said barrel.

7. The liner bolt removal tool according to claim 6, wherein said latch connector is on a rear cap assembly disposed between said second end of said barrel and said rear valve assembly.

8. The liner bolt removal tool according to claim 1, wherein said front end cap assembly further comprises a spring disposed around said impactor, said spring configured to hold said impactor in a firing position.

9. The liner bolt removal tool according to claim 8, wherein said limiting means comprises an impactor spring and a spring retainer disposed around said impactor.

10. The liner bolt removal tool according to claim 1 further comprising a bolt guide at said first end of said front end cap assembly, said bolt guide comprising a spring mounted guide ring.

11. The liner bolt removal tool according to claim 1 further comprising an impact absorbing means disposed at said second end of said front end cap assembly for absorbing the impact of said projectile against said second end of said front end cap assembly.

12. The liner bolt removal tool according to claim 11, wherein said impact absorbing means limits movement of said impactor upon contact of projectile against said second end of said front end cap assembly.

13. The liner bolt removal tool according to claim 1 further comprising a front valve assembly at said first end of said barrel, said front valve assembly configured to vent air from inside said chamber during the forward movement of said projectile.

14. The liner bolt removal tool according to claim 13, wherein said front valve assembly is further configured to deliver compressed air to said first end of said barrel to move said projectile from said first end of said barrel to said second end of said barrel.

15. The liner bolt removal tool according to claim 1 further comprising a suspension assembly attached to said tool.

16. The liner bolt removal tool according to claim 1, wherein said tool is configured to be mounted on a frame.

17. The liner bolt removal tool according to claim 1 further comprising a pair of side bars attached to said outer surface of said barrel, said pair of side bars attached on opposite sides of said barrel parallel to the longitudinal axis of said barrel.

18. The liner bolt removal tool according to claim 17, wherein each of said pair of side bars are adapted for mounting said rear valve assembly thereto.

19. The liner bolt removal tool according to claim 17, wherein each of said pair of side bars are adapted for mounting said front end cap assembly thereto.

20. A liner bolt removal tool for removing a liner bolt, comprising:
a tubular barrel having a first end, an opposing second end, an outer surface and a chamber disposed therein;
a projectile slidably disposed in said chamber of said barrel, said projectile having a first end and a second end, said second end of said projectile having a projectile connector thereon;
a front end cap assembly at said first end of said barrel, said front end cap assembly having a first end, second end and an impactor reciprocately disposed therein, said impactor having a first end to impact the liner bolt and a second end in communication with said chamber of said barrel to be impacted by said projectile;
a rear valve assembly at said second end of said barrel, said rear valve assembly having an inlet adaptable for connection to a supply of compressed air and an outlet in communication with said chamber for delivery of compressed air to said chamber to project said projectile against said second end of said impactor;
a latch connector at said second end of said barrel, said latch connector configured to releasably connect to said projectile connector on said projectile; and
a front valve assembly at said first end of said barrel, said front valve assembly configured to vent air from inside said chamber during the forward movement of said projectile and to deliver compressed air to said first end of said barrel to move said projectile from said first end of said barrel to said second end of said barrel.

21. The liner bolt removal tool according to claim 20, wherein said projectile is generally cylindrical and made from a first material that is softer than a second material used for said impactor.

22. The liner bolt removal tool according to claim 21 herein said first end of said projectile is shaped and configured to expand upon impact with said impactor without an increase in the diameter of said projectile.

23. The liner bolt removal tool according to claim 20 further comprising a bolt guide at said first end of said front end cap assembly, said bolt guide comprising a spring mounted guide ring.

24. The liner bolt removal tool according to claim 20 further comprising an impact absorbing means disposed at said second end of said front end cap assembly for absorbing the impact of said projectile against said second end of said front end cap assembly.

25. The liner bolt removal tool according to claim 24, wherein said impact absorbing means limits movement of said impactor upon contact of projectile against said second end of said front end cap assembly.

26. The liner bolt removal tool according to claim 20 further comprising a pair of side bars attached to said outer surface of said barrel, said pair of side bars attached on opposite sides of said barrel parallel to the longitudinal axis of said barrel, each of said pair of side bars adapted for mounting said rear valve assembly and said front end cap assembly thereto.

27. A liner bolt removal tool for removing a liner bolt, comprising:
a tubular barrel having a first end, an opposing second end, an outer surface and a chamber disposed therein;
a cylindrical projectile slidably disposed in said chamber of said barrel, said projectile having a first end and a second end, said first end of said projectile shaped and configured to expand without an increase in the diameter of said projectile, said second end of said projectile having a projectile connector thereon;
a front end cap assembly disposed at said first end of said barrel, said front end cap assembly having a first end, second end and an impactor reciprocately disposed therein, said impactor having a first end to impact the liner bolt and a second end in communication with said chamber of said barrel to be impacted by said projectile;
impact absorbing means disposed at said second end of said front end cap assembly for absorbing the impact of said projectile against said second end of said front end cap assembly;
a rear valve assembly disposed at said second end of said barrel, said rear valve assembly having an inlet adaptable for connection to a supply of compressed air and an outlet in communication with said chamber for delivery of compressed air to said chamber to project said projectile against said second end of said impactor;
a latch connector at said second end of said barrel, said latch connector configured to releasably connect to said projectile connector on said projectile; and
a front valve assembly at said first end of said barrel, said front valve assembly configured to vent air from inside said chamber during the forward movement of said projectile and to deliver compressed air to said first end of said barrel to move said projectile from said first end of said barrel to said second end of said barrel.

28. The liner bolt removal tool according to claim 27, wherein said impact absorbing means limits movement of said impactor upon contact of projectile against said second end of said front end cap assembly.

29. The liner bolt removal tool according to claim 27 further comprising a bolt guide at said first end of said front end cap assembly, said bolt guide comprising a spring mounted guide ring.

30. The liner bolt removal tool according to claim 27, wherein said projectile is made from a first material that is softer than a second material used for said impactor.

31. The liner bolt removal tool according to claim 27 further comprising a pair of side bars attached to said outer surface of said barrel, said pair of side bars attached on opposite sides of said barrel parallel to the longitudinal axis of said barrel, each of said pair of side bars adapted for mounting said rear valve assembly and said front end cap assembly thereto.
